(19) United States
(12) Patent Application Publication
(10) Pub. No.: US 2014/0220928 A1
(43) Pub. Date: Aug. 7, 2014

(54) RECORDS EXCHANGE SYSTEM AND METHOD FOR MOBILE BROADBAND ROAMING

(71) Applicant: TATA COMMUNICATIONS (AMERICA) INC., Herndon, VA (US)

(72) Inventors: NING SO, Plano, TX (US); Brian Peebles, Cranford, NJ (US)

(73) Assignee: TATA COMMUNICATIONS (AMERICA) INC., Herndon, VA (US)

(21) Appl. No.: 13/757,100

(22) Filed: Feb. 1, 2013

(51) Int. Cl. H04W 8/02

(52) U.S. Cl. CPC H04W 8/02
USPC 455/406; 455/433

(57) ABSTRACT

A method in support of wireless roaming comprising filtering selected mobile subscriber data for a mobile subscriber based on data exchange packages that are established pursuant to bilateral records exchange agreements, transmitting the filtered data to a wireless networks that provides broadband roaming service to the mobile subscriber, receiving information from a visited network about the mobile subscriber's activity therein, and settling charges between wireless networks that provided service to the subscriber.

### STATEMENT OF RELATED CASES

This case is a continuation-in-part of U.S. patent application Ser. No. 13/724,956, which was filed on Dec. 21, 2012 and is incorporated herein by reference. If there are any contradictions or inconsistencies in language between this application and the case that has been incorporated by reference that might affect the interpretation of the claims in this case, the claims in this case should be interpreted to be consistent with the language in this case.

### FIELD OF THE INVENTION

The present invention relates to wireless telecommunications, and more particularly to mobile broadband roaming.

### BACKGROUND OF THE INVENTION

In wireless telecommunications, “roaming” is the ability for a cellular customer to automatically make and receive voice calls, send and receive data, or access other services, including home data services, when travelling outside the geographical coverage area of the home network, by using a network other than the home network—a “visited” network. Roaming is implemented by mobility management, authentication, authorization and billing procedures. For a subscriber to “latch” on to a visited network, a roaming agreement must be in place between the operators of the visited mobile network and the home mobile network.

Before a mobile subscriber gains access to a visited network, the visited network requests certain information from the home network about the subscriber. The information is used by the visited network to authenticate the subscriber and to check their authorization for using the network services. The “visiting” subscriber acquires an entry in a user database of the visited network (the Visited Location Register or “VLR” in GSM networks) and the authorized network services are enabled.

The usage by a subscriber in a visited network is captured in a file called the TAP (Transferred Account Procedure) for GSM or CIBER (Cellular Intercarrier Billing Exchange Record) for CDMA, AMPS. The TAP/CIBER file, which contains details of the calls made by the subscriber, including location, calling party, called party, time of call and duration, and the like is transferred to the home network. The TAP/CIBER files are rated as per the tariffs charged by the visited operator. The home operator then bills these calls to its subscribers and may charge a mark-up/tax applicable locally. More recently, many carriers have launched retail rate plans and bundles for Roaming, so that TAP/CIBER records are generally used for wholesale Inter-Operators settlements only.

Data roaming refers to the use of out-of-network mobile data services. The most common mobile data roaming services include:
MMS: Exchanging rich multimedia messages with other customers on GSM/3G networks.
Push e-mail: Reading and replying to e-mails while abroad, automatically ‘pushed’ to mobile devices.
Handset internet: Using mobile devices to access internet services such as Web pages, music downloads and video streaming.
Mobile broadband: Connecting laptops via data cards or USB dongles to the internet to provide access to common applications such as e-mail, Web browsers and company networks.

The usage of mobile data services is typically measured in kilobytes (KB) and megabytes (MB), which refers to the volume of data transmitted for the service used. An e-mail without an attachment is typically between 1 and 50 KB, an average Web page can use several 100 KBs or more depending on the number of graphical elements, and a downloaded song usually requires 2 to 5 MBs, depending on quality and length. As a consequence, the traffic volume in a typical day of data roaming can vary significantly depending on type and usage intensity of the different services.

As a consequence of the trend towards higher volumes of data downloaded, mobile network operators have introduced new tariff packages, including flat-rate daily bundles, which offer much lower prices per megabyte downloaded than were previously available.

When a mobile subscriber is roaming, the home network operator has a limited ability to control the subscriber's behavior in the visited network. It would be advantageous for the home operator to retain a greater measure of control of its subscribers.

### SUMMARY OF THE INVENTION

The invention provides a way for a home mobile network operator (“MNO”) to retain control over roaming mobile subscribers while, at the same time:
enables the visited MNO to enforce negotiated and agreed-upon policies on the roaming subscribers, thereby protecting their own network utilization; and
enables the visited MNO to monetize the roaming subscriber by offering services to them that would be of potential interest.

In accordance with the illustrative embodiment of the present invention, selected mobile subscriber records are transmitted from a subscriber's home MNO to a Records Exchange System.

The Records Exchange System, which in the illustrative embodiment is implemented as a data processing system including a transceiver, a processor, and processor-accessible storage, provides secure storage of the selected subscriber records for one or more mobile subscribers of one or more MNOs.

Records exchange agreements are in place among the MNOs using the Records Exchange System. A records exchange agreement defines, among other items, what information a first mobile network is willing to share with a second mobile network operator and vice-versa (i.e., the exchange agreements are typically bilateral). Chief among the information being shared is information about the mobile subscribers.

In accordance with the illustrative embodiment, Data Exchange Packages (“DEPs”) are developed from the exchange agreements. The DEPs define, among other items, what particular information within the mobile subscriber record that is stored at the Records Exchange System can be forwarded to any other MNO. The DEPs can be analogized to a filter that filters the mobile subscriber records. That is, the processor of the Record Exchange System executes specialized software that, in conjunction with the DEPs, extracts certain information from the mobile subscriber records. The “filtered” record can then be transmitted to one or more mobile networks, such as a network that has latched on to a mobile subscriber who will begin “roaming” in that network. In this fashion, the home MNO controls what information about its subscribers is available to a visited network.

Since the exchange agreement between any two network operators is likely to differ in some ways from the exchange agreements between any other pairing of operators, the Records Exchange System is likely to include many different DEPs, each applicable to a different pairing of mobile networks. The DEPs can also differ at the subscriber level. As such, a DEP can be a function of (1) the MNO that is to receive the filtered record; and/or (2) the mobile subscriber whose records are being filtered.

In some other embodiments, records exchange agreements and corresponding DEPs are “automatically” established once an MNO joins the Record Exchange System. In yet some further embodiments, if exchange agreements are not established among one or more MNOs of the Record Exchange System, a default agreement and corresponding DEP(s) are established that permits some limited amount of information to be exchanged as between those MNOs.

The filtered mobile subscriber record provides information about a mobile subscriber that was hitherto unavailable to a visited MNO, such as, for example, network usage control, black list (web sites) control, parental control, fair usage, etc. The filtered mobile subscriber record also optionally contains rules, parameters, and/or guidelines that control subscriber non-specific interactions between the home network and the visited MNO.

The filtered mobile subscriber record therefore enables and requires the visited MNO to enforce the agreed-upon policies on roaming subscribers. And that implicitly gives the home MNO a greater measure of control over its subscribers than would otherwise be the case. Furthermore, the detailed information available in the filtered mobile subscriber records might provides the visited MNO with some insight into services that might be of interest to a roaming mobile subscriber. The information provided in the filtered mobile subscriber records thus effectively enables enhanced cooperation between networks that may tend to decrease the tendency for a visited network to attempt to poach another network's mobile subscriber.

In a first embodiment, a method in accordance with the disclosure comprises:

receiving, at a data processing system, one or more first signals comprising selected mobile subscriber data for a first mobile subscriber from a first participating mobile network operator (MNO);

filtering, in the data processing system, the selected mobile subscriber data using a first data exchange package that is applicable to the first mobile subscriber and a second participating MNO, thereby generating a first filtered mobile subscriber record;

transmitting, from the data processing system to the second participating MNO, the first filtered mobile subscriber record via one or more second signals;

receiving, at the data processing system, at least one or more third signals from the second participating MNO, wherein the third signal conveys information pertaining to activity of the first mobile subscriber in the second participating MNO's network; and

apportioning, in the data processing system, charges applicable to the first mobile subscriber for services provided thereto by the first participating MNO and the second participating MNO, between the first participating MNO and the second participating MNO.

In a second embodiment, a method in accordance with the disclosure comprises:

receiving, at a data processing system, one or more first signals comprising first selected mobile subscriber data for a first mobile subscriber from a first participating mobile network operator (MNO);

receiving, at a data processing system, one or more second signals comprising second selected mobile subscriber data for a second mobile subscriber from a second participating mobile network operator (MNO);

filtering, in the data processing system, the first selected mobile subscriber data using a first data exchange package that is applicable to the first mobile subscriber and the second participating MNO, thereby generating a first filtered mobile subscriber record;

filtering, in the data processing system, the second selected mobile subscriber data using a second data exchange package that is applicable to the second mobile subscriber and a third participating MNO, thereby generating a first second mobile subscriber record;

transmitting, from the data processing system to the second participating MNO, the first filtered mobile subscriber record via one or more third signals;

transmitting, from the data processing system to the third participating MNO, the second filtered mobile subscriber record via one or more fourth signals;

receiving, at the data processing system, at least one or more fifth signals from the second participating MNO, wherein the fifth signal conveys information pertaining to activity of the first mobile subscriber in the second participating MNO's network; and

receiving, at the data processing system, at least one or more sixth signals from the third participating MNO, wherein the sixth signal conveys information pertaining to activity of the second mobile subscriber in the third participating MNO's network.

In a third embodiment, a method in accordance with the disclosure comprises:

filtering, in a data processing system, selected mobile subscriber data for a mobile subscriber of a first participating mobile network operator (MNO) using a first data exchange package that is applicable to the mobile subscriber and a second participating MNO, thereby generating a first filtered mobile subscriber record;

transmitting, from the data processing system to the second participating MNO, the first filtered mobile subscriber record via one or more first signals;

receiving, at the data processing system, at least one or more second signals from the second participating MNO, wherein the second signal conveys information pertaining to activity of the first mobile subscriber in the second participating MNO's network; and

settling, in the data processing system, charges applicable to the first mobile subscriber for services provided thereto by the first participating MNO and the second participating MNO.

The foregoing summary provides a few embodiments of the present invention; additional embodiments are depicted in the appended Drawing and the following Detailed Description and the claims.

### BRIEF DESCRIPTION OF THE DRAWINGS

FIG. 1 depicts Records Exchange System 100 in accordance with the illustrative embodiment of the present invention.

FIG. 2 depicts a block diagram of an illustrative hardware platform for the Records Exchange System of FIG. 1.

FIG. 3 depicts content within processor-accessible storage of the Records Exchange System of FIG. 1.

FIG. 4 depicts further details about the content of processor-accessible storage shown in FIG. 3.

FIG. 5 depicts a flow diagram of a method in accordance with the illustrative embodiment of the present invention.

FIG. 6 depicts a method whereby the System's secure record keeper is populated with selected mobile subscriber data and mobile subscriber opt-in list and Participating MNO list are populated.

FIG. 7 depicts a method for filtering mobile subscriber records, in accordance with the illustrative embodiment of the present invention, using a record abstraction process of the Records Exchange System of FIG. 1.

FIG. 8 depicts a method for updating mobile subscriber records based on information received from a visited network, in accordance with the illustrative embodiment of the present invention.

FIGS. 9 through 17 depict broadband roaming via the Records Exchange System of FIG. 1.

### DETAILED DESCRIPTION

Certain terms/phrases will be explicitly defined, when and where context permits, in this Detailed Description. Such definitions are to be used for the interpretation of these terms/phrases, and their inflected forms, as used herein and in the appended claims. Furthermore, the following acronyms may appear in the description and are reproduced below for convenience:
“DEP” for data exchange package;
“FMSR” for filtered mobile subscriber record;
“MEO” for mobile exchange operator (and used synonymously with Records Exchange System);
“MNO” for mobile network operator;
“MSR” mobile subscriber record;
“RAP” for record abstraction process; and
“SRK” for secure records keeper.

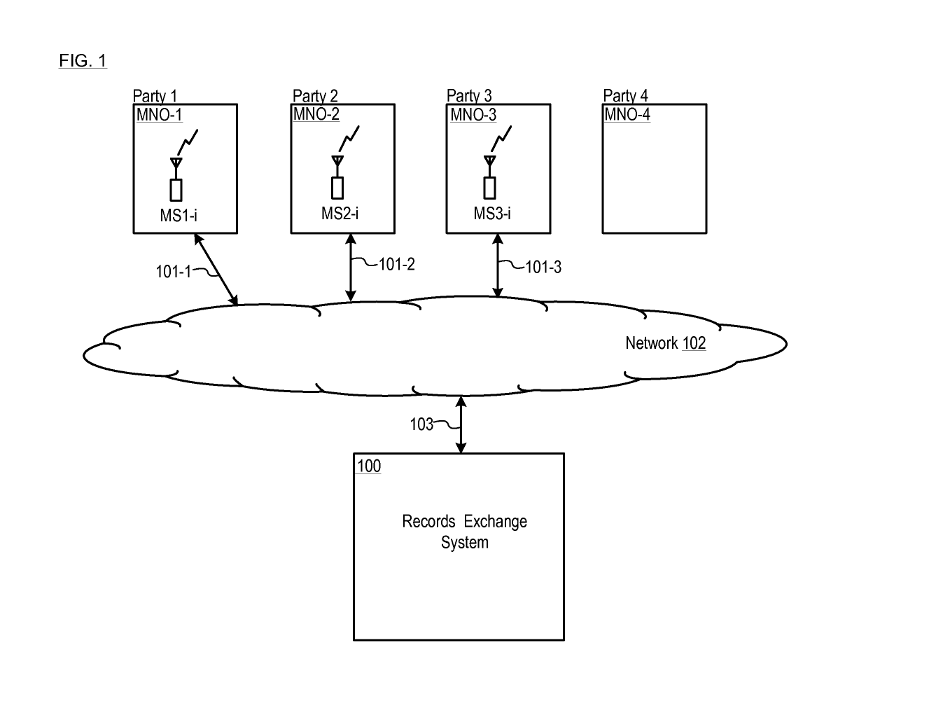

FIG. 1 depicts Records Exchange System 100, network 102, and four parties MNO-1 through MNO-4 that potentially utilize system 100.

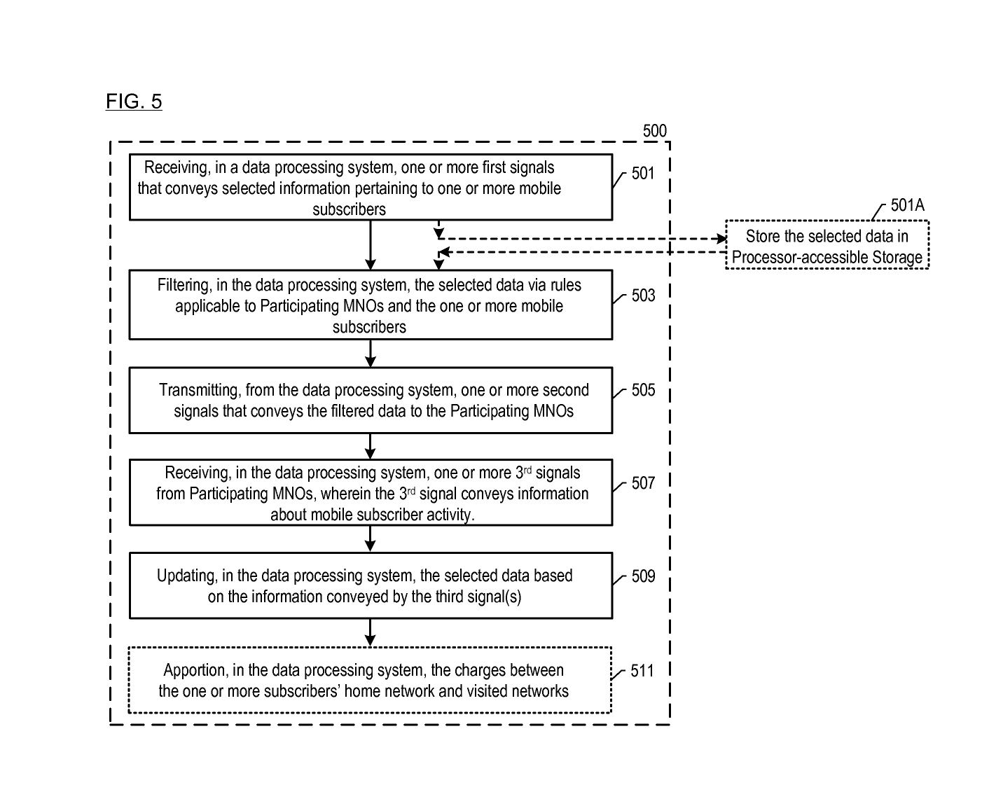

In the illustrative embodiment, the parties MNO-1 through MNO-4 are mobile network operators (“MNOs”). An MNO operates a wireless voice network and typically a wireless data network for providing wireless service to subscribers, in well known fashion. Examples of MNOs include Verizon Wireless, AT&T Mobile, and the like. The terms “mobile network operator” or “MNO” and “mobile network” will be used somewhat interchangeably herein. In some passages, the distinction between “operator” and “network” is not apparent. In other passages, it will be apparent that it is the “network” or the “operator” of the network, which is being referenced. No particular significance is to be attached to the use herein one or the other of these terms. Additional information about the architecture of mobile networks, as is germane to the present invention, is discussed later in conjunction with FIG. 5.

An MNO availing itself of the functionality of Records Exchange System 100 is referred to herein as a “Participating MNO.” As used in this Description and the appended claims, the term “Participating MNO” means:
an MNO that provides information about its subscribers to Records Exchange System 100;
an MNO that receives information from Records Exchange System 100, wherein the received information pertains to:
   (i) the subscribers of one or more other Participating MNOs and is typically, but not necessarily, a subset of the information that such other Participating MNOs have provided to the Records Exchange System about their own subscribers; and/or
   (ii) information about the activity of its own subscribers, wherein such activity occurs when the subscriber is being serviced by one or more of the other Participating MNOs using Records Exchange System 100.

MNO-1 provides service (wireless and/or data) to the mobile stations (e.g., cell phones, etc.) of a number of mobile subscribers MS1-i, i=1, p, wherein p, the number of subscribers of the network, is typically a very large number (e.g., hundreds of thousands, etc.). Likewise, Participating MNO-2 and Participating MNO-3 provide wireless service to a large number of mobile subscribers MS2-i and MS3-i, respectively. MNO-4 does not communicate with Records Exchange System 100 and is not a Participating MNO.

It will be understood that virtually any number of Participating MNOs can utilize Records Exchange System 100; that is, fewer than the three such MNOs shown in FIG. 1 and, more typically, far more than three MNOs will use the system.

Records Exchange System 100 is a data processing system that enables information to be securely exchanged between Participating MNOs, such as MNO-1, MNO-2, and MNO-3, which would not normally share such information. The information being exchanged between Records Exchange System 100 and the Participating MNOs will typically, but not necessarily, be information pertaining to mobile subscribers (e.g., account information, device information, personal information, etc.) of one or more MNOs. Further description of Records Exchange System 100, including an illustrative implementing hardware platform and the operation of the system, is provided later in this specification.

In the illustrative embodiment, Records Exchange System 100 is owned and/or operated by an Exchange operator that is independent of Participating MNOs MNO-1 through MNO-3. In some other embodiments, at least one Participating MNO will have at least a partial ownership interest or operational responsibility in Records Exchange System 100.

Network 102 is one or more data networks, such as the internet. Information, such as mobile subscriber information, is transmitted between MNO-1 through MNO-3 and Records Exchange System 100 via network 102 through respective bilateral wired or wireless telecommunications links 101-1 through 101-3, and 103.

The Participating MNOs each operate a conventional mobile telecommunications network capable of handling voice and data traffic. The design and operation of such networks are well understood by those skilled in the art.

The mobile communications networks include an HLR or HSS. The HLR is the central subscriber data base in GSM networks and the HSS is an “evolved” version of the HLR as used in an IP Multimedia Subsystem (ISM) network. The records of mobile subscribers of a given network are maintained in the HLR/HSS. If the network is a GSM network, it will include a VLR, which contains an entry for each mobile station that is visiting the network. ISM networks do not include a VLR; entries for visiting mobile stations are maintained in the HSS. The formal differentiation between “home” network and “visited” network is the type of the subscriber entry given to a mobile user. If a subscriber has no entry in the HLR (or HSS) of a network, then the network is a “visited” network.

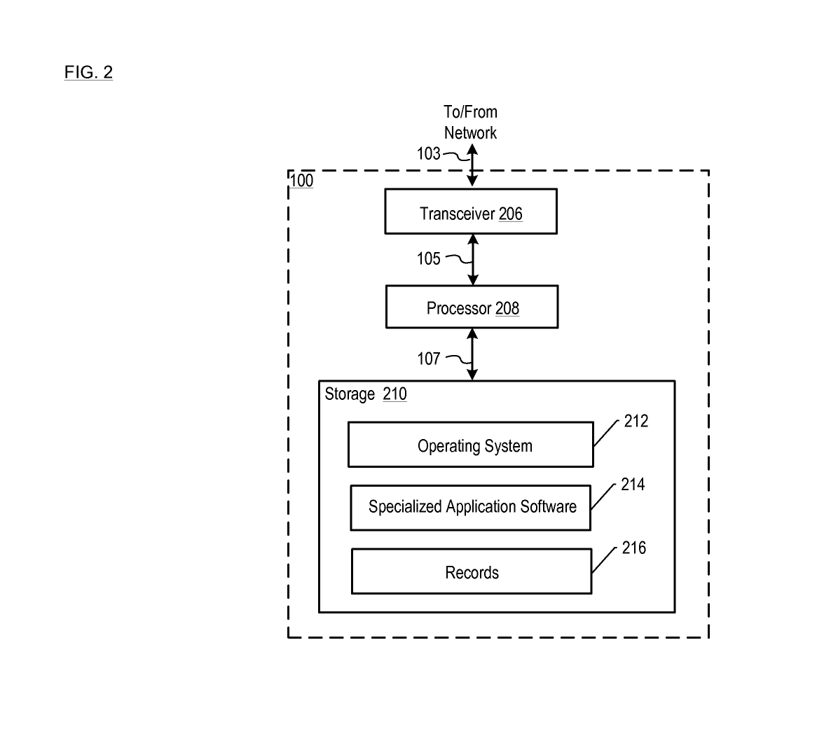

FIG. 2 depicts a block diagram of the salient components of an illustrative hardware platform for implementing Records Exchange System 100 of FIG. 1. In the embodiment depicted in FIG. 2, Records Exchange System 100 is a data processing system comprising transceiver 206, processor 208, and processor-accessible storage 210, interrelated as shown.

In the illustrative embodiment, processor 208 is a general-purpose processor that is capable of, among other tasks, running Operating System 212, executing Specialized Application Software 214, and populating, updating, using, and managing Records 216 in processor-accessible storage 210. In some alternative embodiments of the present invention, processor 208 is a special-purpose processor. It will be clear to those skilled in the art how to make and use processor 208.

Processor-accessible storage 210 is a non-volatile, non-transitory memory technology (e.g., hard drive(s), flash drive(s), etc.) that stores Operating System 212, Specialized Application software 214, and Records 216, whether of an intermediate or archival nature. It will be clear to those skilled in the art how to make and use alternative embodiments that comprise more than one memory, or comprise subdivided segments of memory, or comprise a plurality of memory technologies that collectively store Operating System 212, Specialized Application Software 214, and Records 216.

Transceiver 206 enables Records Exchange System 100 to (i) transmit information-conveying signals to network 102 for transmission, ultimately, to the Participating MNOs and (ii) to receive information-conveying signals from network 102, which are typically ultimately sourced from the Participating MNOs. It will be clear to those skilled in the art, after reading this specification, how to make and use transceiver 206.

It is to be understood that FIG. 2 depicts one embodiment of a data processing system that implements Records Exchange System 100; a variety of other hardware platforms or arrangements can suitably be used. For example, system 100 can be implemented in a virtual computing environment. In some embodiments, multiple processors can be used, wherein different processors execute different Specialized Application Software programs. The use of multiple processors may be advantageous or necessary as a function of the amount of data (e.g., mobile subscriber records, etc.) being processed by Records Exchange System 100.

Furthermore, in some embodiments of system 100, the various elements depicted in FIG. 2 are co-located with one another. In some other embodiments, one or more of the elements is not co-located with the remaining elements. For example, in some embodiments, processor-accessible storage 210 is not co-located with processor 208. And as previously disclosed, processor-accessible storage 210 can be multiple separate memories, one or more of which can be physically remote from processor 208. For instance, in some embodiments, the mobile subscriber information for subscribers of a particular MNO (which in the illustrative embodiment is contained in Records 216) can be stored in a memory that is hosted at the premises of that MNO whereas other information contained in Records 216 can be stored in a memory hosted elsewhere (e.g., at the premises of the records exchange operator, etc.).

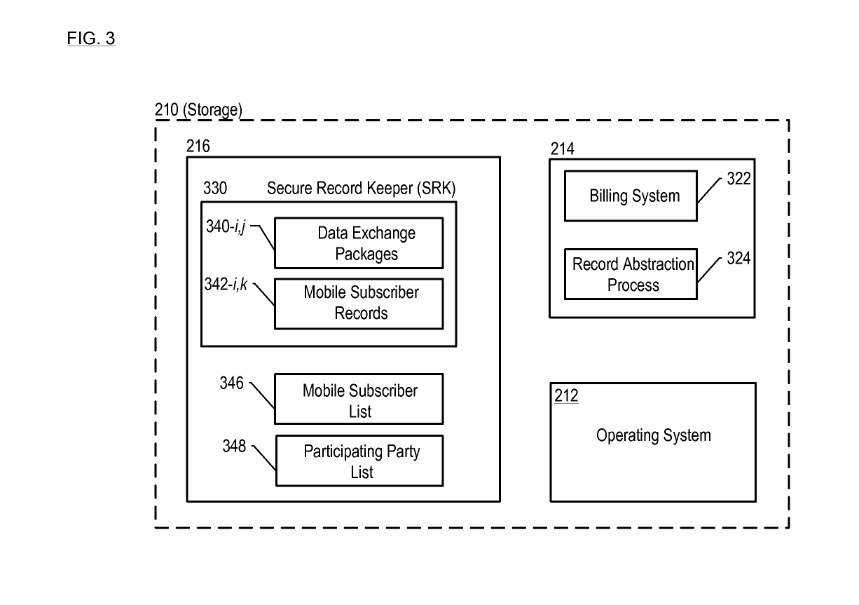

FIG. 3 depicts, for the illustrative embodiment, further detail about the contents of processor-accessible storage 210. As depicted in FIG. 3, Records 216 includes:
Data Exchange Packages 340-i,j;
Mobile Subscriber Records 342-i,k;
Mobile Subscriber Opt-in List 346;
Participating MNO List 348.

In accordance with the illustrative embodiment, an MNO wishing to avail itself of the services provided by Records Exchange System 100 “opts-in” to the system (thereby becoming a Participating MNO). The opt-in process includes, in the illustrative embodiment, executing individual bi-lateral records exchange agreements between the MNO wishing to opt-in and all other Participating MNOs. The bi-lateral agreements control, among other issues, the amount/type of mobile-subscriber information that the NMOs will share with one another. In some other embodiments, records exchange agreements are “automatically” established once an MNO opts-in to the Record Exchange System. In yet some further embodiments, if exchange agreements are not established among one or more MNOs of the Record Exchange System, a default agreement is used that permits some limited amount of information to be exchanged as between those MNOs.

In some embodiments, a list—Participating MNO List 348—provides the identity of all MNOs that have opted-in to Records Exchange System 100. This identifier can be used to reference a specific Participating MNO within Records 216.

As a consequence of strict confidentiality/privacy concerns and, in some cases, privacy laws, individual mobile subscribers “opt-in” to Records Exchange System 100 in the illustrative embodiment. In other words, in the illustrative embodiment, even though a subscriber's home MNO has opted-in to System 100, each mobile subscriber independently “opts-in,” thereby explicitly providing permission to the home MNO and Records Exchange System 100 to share the subscriber's confidential records with other Participating MNOs. In some other embodiments, an explicit opt-in is not performed (e.g., permission can be obtained outside the context of Records Exchange System 100, or permission can be implicit in view of participation by the mobile subscriber in other services the home MNO provides, etc.). In some embodiments, Mobile Subscriber list 346 “identifies” all mobile subscribers that opt-in to Records Exchange System 100. In some embodiments, List 346 will not explicitly reference the identity (i.e., the name) of the mobile subscriber. Rather, for example, List 346 includes the International Mobile Subscriber Identity (“IMSI”), Temporary Mobile Subscriber Identity (“TMSI”), or the like, or, alternatively, “de-identification technologies” can be used to protect the actual identity of any particular mobile subscriber.

As depicted in FIG. 3, at least some of the information contained in Records 216 is maintained within Secure Record Keeper (“SRK”) 330. In some embodiments, each participating MNO has its own SRK; in some other embodiments, each MNO has storage location allocated to it within a single “universal” SRK.

However conceptualized or implemented, SRK 330 is a secure region of processor-accessible storage 210. Security can be assured via any one or more of a number of means. For example, a dedicated link (or links) can be used (e.g., layer 1 physical or layer ⅔ virtual dedication) and/or L3 encryption, such as IPsec, can be used. In the illustrative embodiments, the SRK is further secured through data storage encryption, wherein each MNO holds the decryption key for its SRK (or portion thereof). In some other embodiments, data storage encryption can be used as an alternative to other types of security. In the illustrative embodiment, the decryption key is maintained by each MNO at the premises thereof. In further embodiments, the MNOs can store their decryption key within SRK 330. In some embodiments, the stored data is encrypted such that MNOs can prevent any other party from accessing its stored information.

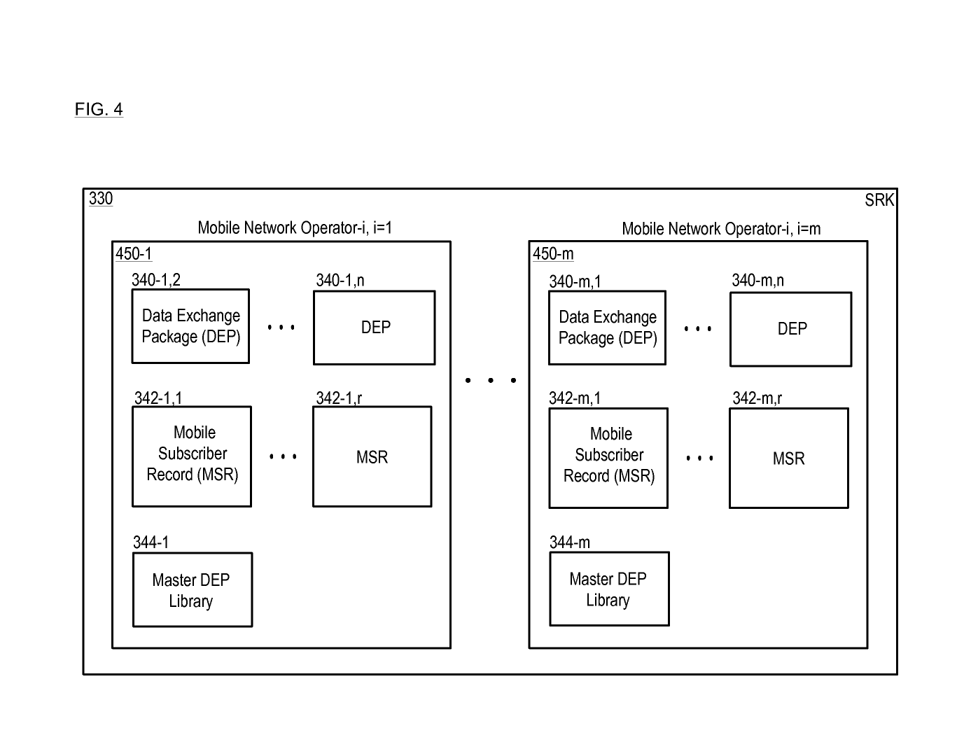

In the illustrative embodiment, the information stored in SRK 330 includes Data Exchange Packages (“DEPs”) 340-i,j and Mobile Subscriber Records (“MSRs”) 342-i,k. In some other embodiments, Mobile Subscriber List 346 is located within SRK 330. In some of such embodiments, each MNO maintains its own list of opted-in mobile subscribers; in some other of such embodiments, a single list of all opt-in mobile subscribers, irrespective of the home network thereof, is maintained in SRK 330. The information contained in DEPs 340-i,j and MSRs 342-i,k is discussed more fully below in conjunction with FIG. 4.

It is to be understood that terms such as “list,” “record,” “package,” etc., are used as a linguistic convenience and are not intended to specify or otherwise limit the manner in which the referenced information is stored or organized. For example, the use of such terms is not intended to require any particular data structure for the stored data. Also, reference to multiple (independent) lists—such as one for opted-in mobile subscribers and another for the Participating MNOs—is not intended to mandate the use of multiple lists; a single list can be used, for example, for storing both Participating MNOs and mobile subscribers. Indeed, one skilled in the art will understand that the information contained in processor-accessible storage 210 can be organized in any convenient manner.

Processor-accessible storage 210 also contains Specialized Application Software 214, which includes, among other software, Billing System 322 and Record Abstraction Process 324.

Billing System 322 comprises processor-executable instructions for apportioning, as appropriate, charges to the mobile subscriber for network access and usage, and fees for service usage, as between a number of different parties. Such parties include the mobile subscriber's home MNO, any Participating MNOs that the subscriber may have “visited” during the invoicing cycle, content providers, application service providers, and the like.

Billing System 322 also ensures that the operator(s) of Records Exchange System 100 is compensated for the services the System provides. This can be done in a variety of ways. In the illustrative embodiment, some portion of the applicable fees/charges otherwise owed to entities in the value chain is allocated, by Billing System 322, to System 100. That is, of the amount invoiced to a mobile subscriber for services provided by MNOs, content providers, and the like, a portion that would otherwise go to those providers accrues to the operator(s) of Records Exchange System 100. In such embodiments, the fees owed to the operator(s) of Records Exchange System 100 can be divided equally or on a pro-rata basis among each Participating MNO (i.e., the home MNO and visited MNOs) involved in transactions or network events applicable to a particular invoice. Alternatively, the fees owed can be divided equally or on a pro-rata basis among all entities in the value chain (Participating MNOs, content providers, etc.). For pro-rata allocation, the fee owed to the Records Exchange System 100 by any particular entity can be based, for example, on that entity's fractional entitlement to the amount owed.

In some embodiments, Participating MNOs are charged a fee for use of Record Exchange System 100, without regard to network usage, etc., by mobile subscribers. In some embodiments, Billing System 322 accesses information contained in SRK 330 to apportion charges/fees. After reading this specification, those skilled in the art will be able to implement Billing System 322 for use in conjunction with Records Exchange System 100.

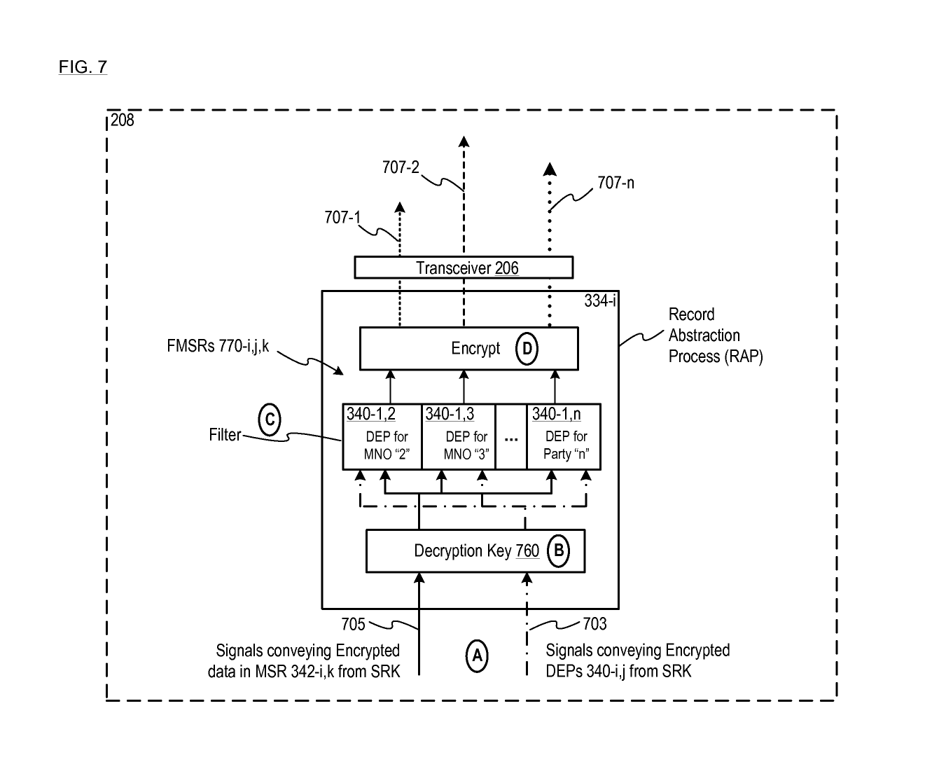

Record Abstraction Process (“RAP”) 324 comprises processor-executable instructions that generate “filtered” mobile subscriber records. The filtering is based on the records exchange agreement, as embodied in the Data Exchange Packages, between the home network (for the particular mobile subscriber) and the particular Participating MNO that will be receiving the filtered mobile subscriber record. More particularly, DEPs 340-i,j are used to filter the information pertaining to any given mobile subscriber, as contained in Mobile Subscriber Records (“MSR”) 342-i,k. The filtered information is typically a sub-set of the information contained in MSR 342-i,k. DEPs 340-i,j are discussed in more detail in conjunction with FIG. 4 and RAP 324 is discussed in more detail in conjunction with FIG. 7.

FIG. 4 depicts further detail of an illustrative embodiment of SRK 330. In the embodiment depicted in FIG. 4, the SRK comprises a plurality of storage blocks 450-i, each of which storage blocks contain:
a plurality of Data Exchange Packages 340-i,j wherein j=1,n
a plurality of Mobile Subscriber Records 342-i,k wherein k=1,r
Master Data Exchange Package Library 344-i.
   In this embodiment, each MNO-i has its own region of secure storage 450-i wherein i=1 μm within SRK 330. The variable “i” is an identifier for the MNO (e.g., MNO-1, MNO-2, etc.). The variable “m” is the number of MNOs that have opted-in to Records Exchange System 100.

The data within a given storage block 450-i pertains to mobile subscribers of the associated MNO-i. Thus, from the perspective of those mobile subscribers, the associated NMO-i is the “home” MNO. For example, for storage block 450-1, the associated MNO is MNO-1 and the data in MSRs 342-1,k pertains to subscribers of MNO-1.

The information in MSRs 342-i,k is sourced from the home MNO of those subscribers. In accordance with the illustrative embodiment, under appropriate conditions (e.g., mobile subscriber opt-in, if necessary, etc.), subscriber information is transmitted from the home MNO to Records Exchange System 100. The information that is transmitted is typically a subset of all information available about a mobile subscriber, such as is available in HLR/HSS of the MNO. As used in this Description and the appended claims, the term “selected mobile subscriber data” means a portion—that is, some but not all—of the information in the possession of the home MNO pertaining to a given mobile subscriber. The home MNO and/or each mobile subscriber and/or applicable law determines what types of information are acceptable to forward to Records Exchange System 100. As such, in the illustrative embodiment, the mobile subscriber record 342-i,k comprises selected mobile subscriber data from the HLR/HSS and other records of the home MNO.

In the illustrative embodiment, each MNO-i has, in its SRK storage 450-i, MSRs for a number “r” of opt-in subscribers. In some other embodiments, MSRs are created for all mobile subscribers of the MNO, whether or not they opt-in. In such embodiments, if a mobile subscriber does not “opt-in,” then the MSR that contains the subscriber's information will not be accessed by RAP 324.

As noted above, an MNO's block of storage 450-i contains a plurality of DEPs 340-i,j wherein j=1,n. The variable “i” is an identifier for the associated MNO and “j” is an identifier for the Participating MNO. In the illustrative embodiment, variable “j” is an absolute identifier (such as can be stored in Participating MNO List 348). That is, assuming that j=1 for MNO-1, DEPs in 450-1 would have indices DEP 340-1,j wherein j≠1. Similarly, for MNO-2, DEPs in 450-2 would have indices DEP 340-2,j wherein j≠2. In other embodiments, j is not a unique identifier.

The variable “n” is the number of Participating MNOs that have executed record exchange agreements with a particular Participating NMO-i. It is likely that at least some Participating MNOs will not establish a data-exchange relationship with every other Participating MNO of Records Exchange System 100. As such, there may be a different number of DEPs 340-i,j within storage 450-i for different MNOs. In other words, the number “n” can vary from MNO to MNO.

As previously, indicated, the Data Exchange Packages or “DEPs” are rules packages that, in the illustrative embodiment, arise from the records exchange agreement executed between the home network and each Participating MNO with which the home MNO is willing to share subscriber information. As previously noted, in some alternative embodiments, records exchange “agreements” can arise by default.

As used in this Description and the appended claims, the term “Data Exchange Package” or “DEP” means:
(i) a set of rules, parameters, and/or guidelines that control what particular information about its mobile subscribers that the home network divulges to another Participating MNO; and optionally
(ii) a set of rules, parameters, and/or guidelines that control subscriber non-specific interactions between the home network and Participating MNOs.
   As explained further below, these rules, parameters, and/or guidelines can be in the form of memory addresses (e.g., in a subscriber's MSR, etc.) at which information that is to be “exchanged” (i.e., forwarded to a Participating MNO) can be found. As to item (i), the determination of what information is acceptable to divulge is determined by at least one of the following: the home network, the mobile subscriber, and applicable laws.

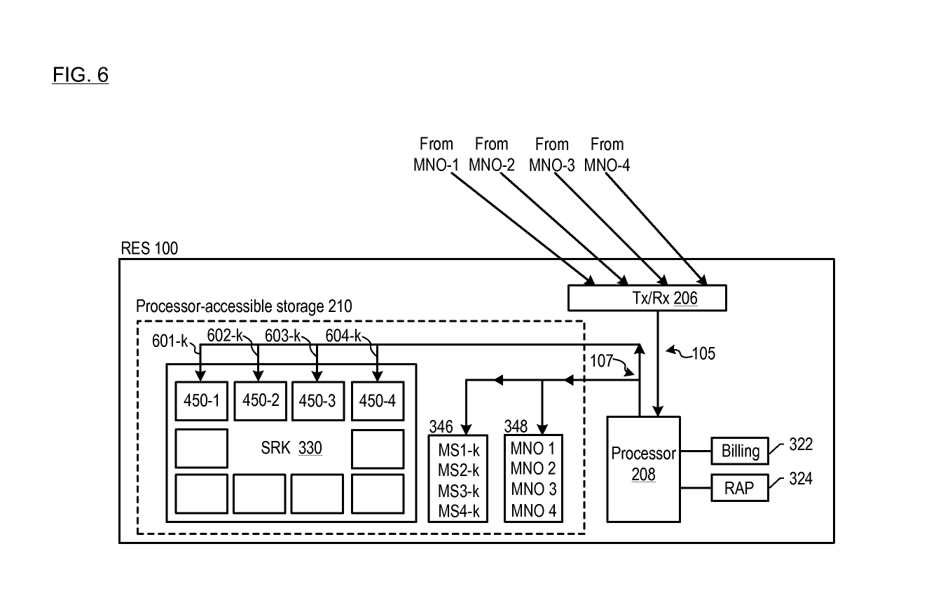

More particularly, and as discussed in further detail later in this specification, in conjunction with the Record Abstraction Process 324, the DEP “filters” information about a particular mobile subscriber, a class of mobile subscribers, or all opted-in mobile subscribers of a particular network. As such, in some embodiments, a given storage block 450-i of an MNO-i within SRK 330 might contain, for each Participating MNO: (i) a different DEP for each mobile subscriber, (ii) different DEPs for different classes of subscribers (e.g., for subscribers age 12 and under, for subscribers age 13-17, and for subscribers age 18 or older, etc.), or (iii) a single DEP for all opt-in mobile subscribers of the home network. A particular DEP can apply to (i) a single Participating MNO, (ii) a class of Participating MNOs, or (iii) or all MNOs. The content and filtering function of DEPs are discussed in further detail in conjunction with FIGS. 6 and 7.

FIG. 5 depicts a flow diagram of the salient tasks in method 500 for records exchange in accordance with the illustrative embodiment of the present invention. Method 500 is discussed in conjunction with FIGS. 6, 7 and 8.

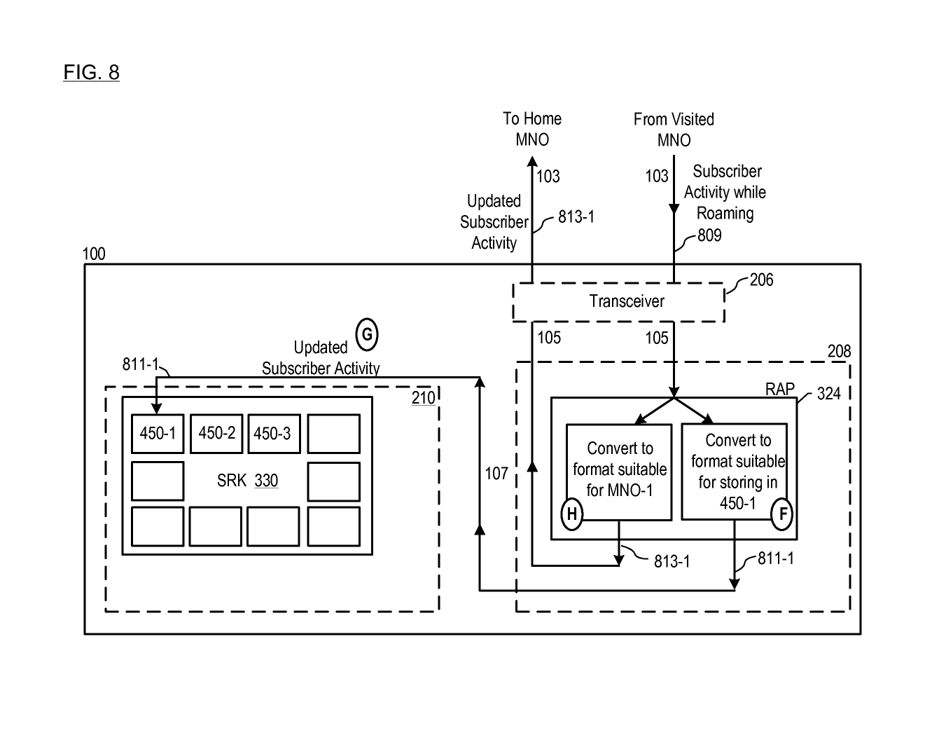

In accordance with method 500 and task 501, Records Exchange System 100 receives one or more first signals conveying selected information. The first signals are transmitted from Participating MNOs and received by transceiver 206, as previously discussed in conjunction with FIGS. 1 and 2. The selected information transmitted by the first signals comprises: (i) information related to one or more mobile subscribers and/or (ii) information related to rules governing interactions between an MNO and the various other Participating MNOs. Additional description of the selected information and the manner in which the received signals are processed is described in conjunction with FIGS. 7 and 8 and elsewhere throughout this Detailed Description.

In the illustrative embodiment, task 501 includes optional sub-task 501A wherein processor 208 causes the received selected information to be stored in processor-accessible storage 210. Due to the typically highly confidential nature of at least some of selected information, its security should be assured. The secure storage of the selected data, and more detail concerning the contents of processor-accessible storage 210 (for embodiments including sub-task 501A), are discussed in conjunction with FIGS. 3 and 4. In some other embodiments (not depicted or further discussed), the selected information is transmitted directly to processor 208 for processing and is not archived in processor-accessible storage 210. Although considered to be optional, sub-task 501A is advantageous and is performed in preferred embodiments of the method.

FIG. 6 depicts tasks 501/501A wherein, in the illustrative embodiment, signals conveying the selected information are transmitted from the Participating MNOs to transceiver 206 of Records Exchange System 100.

In the illustrative embodiment, signal(s) from each Participating MNO convey: (1) an identifier for each subscribers of that MNO that wishes to “opt-in” as well as selected mobile subscriber data of the opt-in subscribers. That information is conveyed to Processor 208 over communications link 105. Participating MNO List 348 is populated with an identifier for the Participating MNOs at some earlier time.

Processor 208 extracts selected mobile subscriber data for each opt-in subscriber of a Participating MNO and conveys it, over communications link 107, to the MNOs storage block 450-i in SRK 330. Thus, signal(s) 601-k conveys the selected mobile subscriber data MSR 342-1,k for each opt-in subscriber MS1-k, k=1,r of MNO-1 to storage block 450-1. Likewise, signal(s) 602-k, 603-k, 604-k convey selected mobile subscriber data for each opt-in subscriber of MNO-2, MNO-3, and MNO-4, respectively, to the appropriate storage block. In the illustrative embodiment, the selected mobile subscriber records bypass RAP 324; mapping operations by which the records are configured for storage is provided by the Participating MNO or other software operating on Processor 208. In conjunction with this Detailed Description, those skilled in the art will know how to process the selected mobile subscriber records for storage in SRK 330.

In accordance with task 503, the selected data pertaining to the mobile subscribers is filtered in accordance with various parameters and rules, as embodied in the Data Exchange Packages governing the interactions between the subscriber's home MNO, the mobile subscribers, and other Participating MNOs. Task 503 is discussed in more detail below in conjunction with FIG. 7.

FIG. 7 depicts an embodiment of Record Abstraction Process 324 wherein filtered mobile subscriber records are generated using DEPs. As previously disclosed, RAP 324 is a specialized software application, executing in processor 208, for use in conjunction with Records Exchange System 100.

FIG. 7 depicts tasks A through D being performed by RAP 324 for a mobile subscriber of MNO-1. In that regard, there is a discrete instantiation of the RAP for each MNO-i.

In accordance with task A, the RAP causes appropriate DEPs 340-1,j (e.g., 340-1,2; 340-1,3; etc.) as stored in storage block 450-1 (for MNO 104-1) in SRK 330, to be copied (into registers that are available) to processor 208. Signals 703 convey the copied DEPs from processor-accessible storage 210 to processor 208. In some embodiments, the DEPs are encrypted. In such embodiments, the DEPs are decrypted via the MNO's decryption key 760, as per task B. Per task A, RAP 324 also causes a copy of appropriate mobile subscriber records 342-1,k, as stored in the MNO-1 storage block 450-1 in SRK 330, to be transmitted to processor 208. Signal(s) 705 convey the copied mobile subscriber record(s) MSR 342-1,k from processor-accessible storage 210 to processor 208. In the illustrative embodiment, the MSR is encrypted, so, at task B, MSR 342-1,k is decrypted via decryption key 760 of MNO-1.

At task C, the mobile subscriber record(s) 342-1,k is “filtered” by DEPs 340-1,2; 340-1,3; . . . 340-1,n to generate filtered mobile subscriber records (“FMSR”) 770-i,j,k. Each DEP 340-i,j can be conceptualized as a “comb” filter that (i) filters the mobile subscriber record and, in the illustrative embodiment, (ii) also filters a master set of usage rules established by the home MNO. In some embodiments, MSR 342-i,k is filtered by only those DEPs applicable to Participating MNOs that are to receive an FMSR. In some other embodiments, the MSR is filtered by DEPs for all Participating MNOs, without regard to whether all such Participating MNOs are to receive an FMSR.

Continuing with the “filter” metaphor, and with respect item (i), the subscriber information contained within MSR 342-1,k (i.e., all data pertaining to mobile subscriber k that the home MNO (i.e., MNO-1) has provided to System 100) is presented to a filter, as embodied by DEP 340-1,j. The DEP permits only certain information (i.e., information that is deemed acceptable to forward to Participating MNO-j) within MSR 342-1,k to “pass.” As such, FMSR 770-i,j,k typically contains a sub-set of the subscriber information for subscriber k contained in MSR 342-i,k. As used in this Description and the appended claims, the term “Filtered Mobile Subscriber Record” means a record generated from the selected mobile subscriber records by “filtering” it, as that term is used herein, via a DEP.

There can be, and will typically be, “structural” similarities between different DEPs (e.g., 340-1,2; 340-1,3; etc.). The significance of this is that the home MNO is willing to share some of the same type of information about subscribers with different Participating MNOs. Continuing with the comb-filter metaphor, this means that various DEP “filters” would permit the same information to “pass” the filter. Thus, the filtered information destined for MNO-2 and MNO-3 would include at least some of the same information about mobile subscriber MS1-k. If the filters are, instead, applied to two or more different mobile subscribers of MNO-1, then the resulting filtered information destined for the MNO-2 and MNO-3 would include the same type of information (e.g., the amount of data they can use over a certain period of time, etc.) for all such mobile subscribers.

It will be understood that the DEP does not actually filter the data in the manner shown; this is a metaphor. It is more appropriate to describe the operation of the DEP as “extracting” information from the mobile subscriber records. For example, in some embodiments, the DEP 340-i,j provides the storage locations for information from mobile subscriber records 342-i,k that are to be copied into record FMSR 770-i,j,k destined for Participating MNO-j. These or other arrangements for implementing DEPs, as will occur to those skilled in the art after reading this specification, may suitably be used.

As previously mentioned, DEPs, such as DEPs 340-1,2 and 340-1,3 function as a “filter” for “usage” rules. These usage rules involve, for example, certain policies that the (home) MNO wishes to apply to a Participating MNO. For example, the DEP might extract information from an MSR 342-i,k that dictates, for example, certain actions that the visited MNO must take (or cannot take) with respect to all subscribers from the particular home network that roam into that particular MNO or certain information that the visited MNO must provide to the home MNO. In such an embodiment, the home MNO establishes master DEP library 344-i in its storage block 450-i within SRK 330. After reading this specification, those skilled in the art will be able to implement alternative embodiments in which a master DEP is not employed and usage rules applicable for a Participating Party are obtained in a different manner.

It will be appreciated that although the DEPs are, in the illustrative embodiment, based on information exchange agreements between a (home) MNO and various Participating MNOs, it is advantageous for Records Exchange System 100 to actually create the DEPs using the information contained in the agreements. This is appropriate since to “filter” a mobile subscriber record, the DEPs and RAP 324 must have requisite information concerning the precise storage locations of particular types of information within the subscriber's MSR as well as other detailed processing information.

In accordance with the illustrative embodiment, at task D, FMSRs 770-i,j,k are encrypted. The encryption can be the same as applied to the records kept in the MNO's storage block 450-i. Alternatively, a different encryption scheme implemented by Records Exchange System 100 can be applied at task D.

It is to be understood that the order of tasks A through D is permutable and, furthermore, not all tasks are required in all embodiments. For example, in some embodiments, task C (filtering) occurs before task A (copying). In such embodiments, the DEPs operate on MSRs 342-i,k within the SRK; that is, only the information that will ultimately be transmitted to the Participating MNOs is accessed by RAP 324. In these embodiments, tasks B and D may not be necessary. Furthermore, in scenarios in which encryption is considered unnecessary, task D is optional. In light of this disclosure, those skilled in the art will be able to make and use RAP 324 and the DEPs.

Returning now to the discussion of method 500 of FIG. 5, in accordance with task 505, the filtered mobile subscriber data is conveyed, via one or more second signals transmitted from Records Exchange System 100, to appropriate Participating MNOs. With reference again to FIG. 7, task 505 is implemented as transceiver 206 transmits signals 707 (e.g., 707-1, 707-2, . . . 707-n) to the appropriate Participating MNOs, thereby conveying filtered mobile subscriber records 770-i,j,k thereto.

To the extent that a mobile subscriber is “roaming” in a visited network, and accessing the internet or “consuming” data via other activities, such consumption is advantageously tracked and reported to Records Exchange System 100 and the home MNO. Consequently, task 507 of method 500 recites that the data processing system receives one or more third signals that convey, for example and without limitation, updated subscriber activity from a Participating (and visited) MNO. This enables the archival records (i.e., mobile subscriber records in Records Exchange System 100) to reflect the subscriber's activity (e.g., data usage, etc.) while roaming.

At task 509, Records Exchange System 100 updates its archived mobile subscriber records and/or transmits a signal conveying the updated subscriber records, in an appropriate format, to the home MNO. As described further in conjunction below, this functionality is provided, in accordance with the illustrative embodiment, by RAP 324.

Tasks 507 and 509 are now described in further detail in conjunction with FIG. 8. With continuing reference to task 507 of method 500, Records Exchange System 100 receives, over telecommunications link 103 (see, e.g., FIGS. 1 and 2), third signal 809 from a visited MNO. Third signal 809 conveys information about the “activity” of a mobile subscriber while roaming in a visited wireless network. As used herein, the phrase “The third signal is ultimately conveyed from transceiver 206 over telecommunications link 105 to processor 208.

With respect to task 509, in the illustrative embodiment, RAP 324 (executing in processor 208), receives the subscriber activity conveyed by signal 809 and converts it (if necessary) to a format suitable for storing in storage block 450-i of the home MNO, as depicted at task F. In some embodiments, the conversion process includes decryption and encryption operations, as well as a mapping operation that ensures that the updating information is appropriately organized for storage in the mobile subscriber records of home MNO, as maintained in SRK 330 of processor-accessible storage 210. After conversion, the information pertaining to the updated subscriber activity is stored in the home MNO's storage block 450-i, as per task G. Thus, in FIG. 8, wherein MNO-1 is the home MNO, appropriately mapped and encrypted information is conveyed by signal 811-1 over link 107 to update mobile subscriber record 342-1,k in storage block 450-1 of MNO-1 in SRK 330.

In addition to updating its own records in accordance with task 509 of method 500, System 100 also provides an update of subscriber activity to the home MNO. In the illustrative embodiment, RAP 324 converts the incoming information, as conveyed by signal 809, to a format appropriate for storage at the home MNO, per task H. In some embodiments, the conversion process includes decryption and encryption operations, as well as appropriately mapping the incoming information so that it is correctly interpreted by the home MNO for updating its main subscriber records (e.g., in HLR/HSS 508—see FIG. 5). Signal 813-1 conveys the updated subscriber information to the home MNO over links 105 (processor to transceiver) and 103 (transceiver to network).

In some other embodiments (not depicted), the updating of mobile subscriber records of System 100 is performed “indirectly.” In such embodiments, RAP 324 only performs task H, not tasks F or G. The update subscriber activity, as conveyed by signal 813-1, is transmitted to the home MNO and, once it is received, that MNO's records are updated. Selected records, which include at least some updated records, are then transmitted to Records Exchange System 100 for updating MSRs 342-i,k in the MNOs block 450-i of secure storage in the SRK.

Returning once again to FIG. 5, optional task 511 recites apportioning, in the data processing system, the charges between the one or more subscribers' home network and visited networks. In the illustrative embodiment, at an appropriate time as a function of a subscriber's billing cycle, Billing System 322 aggregates billing data from multiple sources, including, without limitation, network usage events, transactions, and content purchases. Billing System 322 rates the provided services according to an appropriate tariff scheme and ultimately generates an invoice. Billing System 322 further generates revenue sharing data that enables the various providers to share the revenue based on their contributions. Revenue sharing ensures, for example, that a visited network is compensated for access, etc., as a mobile subscriber roams in that network.

Billing System 322 also takes a fee for its services, which, in the context of a specific invoice, is applied to those providers in the value chain that have accessed Records Exchange System 100. System 100 ultimately invoices the appropriate providers. In some other embodiments, System 100 does not handle billing; that is, the MNOs can handle it directly. In some of such embodiments, each Participating MNO pays the operator of Records Exchange System 100 a few for roaming signaling and records exchange, but not for billing.

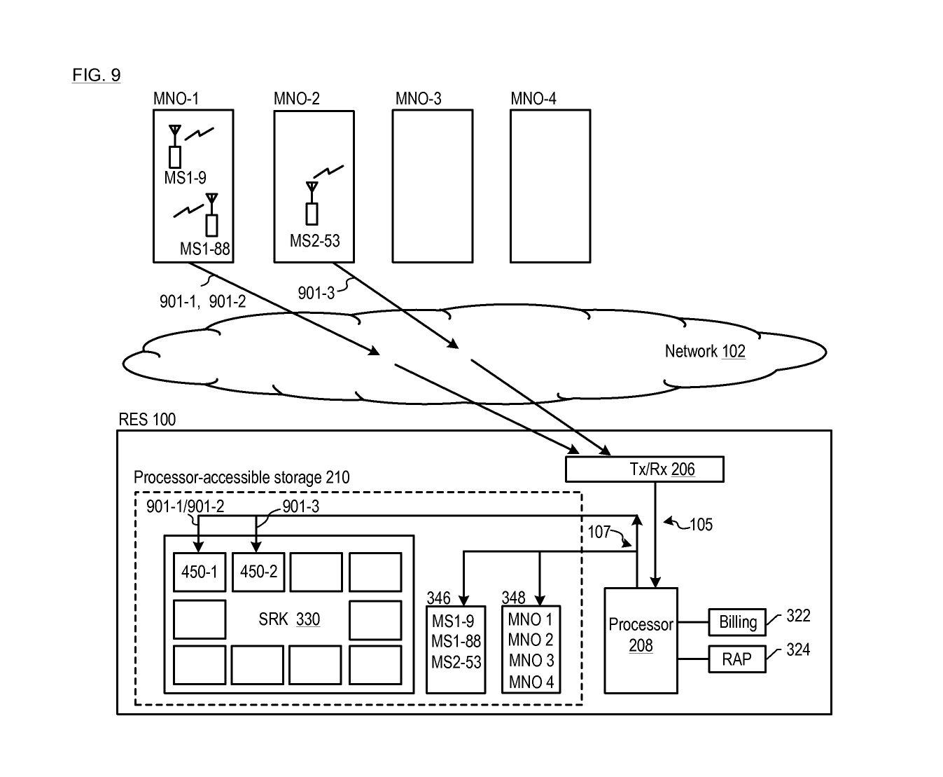

FIGS. 9 through 17 depict an example of using Records Exchange System 100 to support broadband roaming.

Referring now to FIG. 9, MNO-1, MNO-2, MNO-3, and MNO-4 have opted-in to System 100 to become Participating MNOs in the manner previously discussed and as further detailed in U.S. patent application Ser. No. 13/724,956. Each Participating MNOs has many mobile subscribers; subscribers MS1-9 and MS1-88 of MNO-1 and mobile subscriber MS2-53 of MNO-2 depicted in FIG. 9 are illustrative of such subscribers.

FIG. 9 depicts Records Exchange System 100 after opt-in of the Participating MNOs, wherein Mobile Subscriber Opt-in List 346 and Participating MNO List 348 are populated. Furthermore, FIG. 9 depicts selected mobile subscriber records of subscribers MS1-9 and MS1-88 from MNO-1 being transmitted, via signals 901-1 and 901-2, to Records Exchange System 100. FIG. 9 also depicts selected mobile subscriber records of subscriber MS2-53 from MNO-2 being transmitted, via signal(s) 901-3, to Records Exchange System 100.

In the illustrative embodiment, selected mobile subscriber records conveyed by signals 901-1, 901-2, and 901-3 are received by transceiver 206, transmitted over link 105 to processor 208, and transmitted over link 107 and stored in the appropriate storage block 450-i in SRK 330. In the illustrative embodiment, the selected mobile subscriber records bypass RAP 324; mapping operations by which the records are configured for storage is provided by the Participating MNO or other software operating on Processor 208. In conjunction with this Detailed Description, those skilled in the art will know how to process the selected mobile subscriber records for storage in SRK 330.

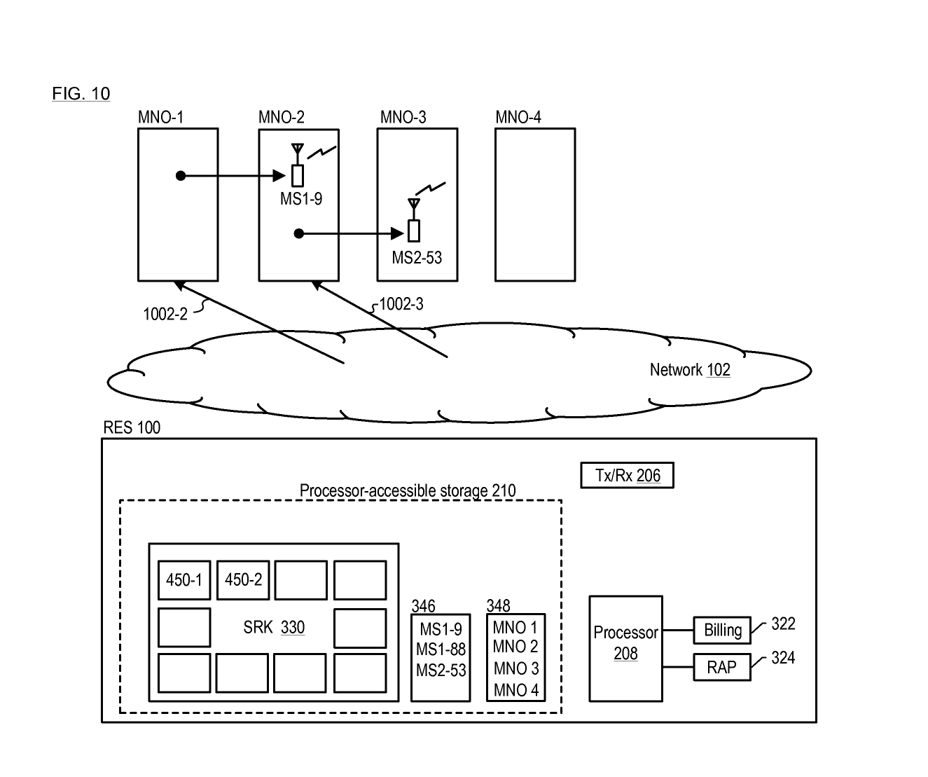

FIG. 10 depicts mobile subscriber MS1-9 leaving its home network (MNO-1) and in preparation for being picked up by MNO-2. FIG. 10 also shows mobile subscriber MS2-53 leaving its home network (MNO-2) and in preparation for being picked up by MNO-3. Network MNO-2 transmits signal 1002-2 to MNO-1 (optionally through System 100) requesting permission to pick up MS1-9. Network MNO-3 transmits signal 1002-3 to MNO-2 (optionally through System 100) requesting permission to pick up MS2-53. In this example, both requesting networks receive permission (not depicted) to pick-up the subscribers in question.

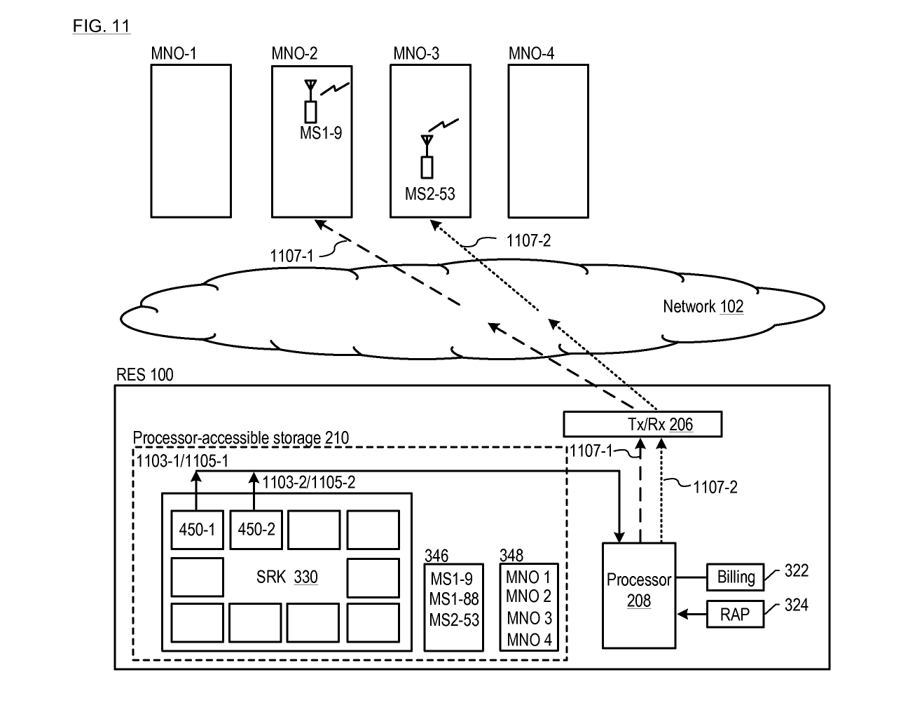

FIG. 11 depicts filtered mobile subscriber records being transmitted, via signals 1107-1 and 1107-2 to respective networks MNO-2 and MNO-3. In the illustrative embodiment, the filtered records are transmitted in response to a request (not depicted) to receive the filtered mobile subscriber records. The request can come from a visited network, such as after that network receives permission to pick up a roaming mobile subscriber. Alternatively, the request can originate from the home network after giving another network permission to pick up one of the home network's subscribers. The filtered records can be transmitted either directly to the visited network, or, alternatively, they can be delivered to the home network for re-delivery to the visited network.

As previously described, the selected mobile subscriber records stored in the SRK are filtered via DEPs to generate the filtered mobile subscriber records for subscribers MS1-9 and MS2-53. Filtered record(s) for MS1-9 are generated by establishing a first instantiation of RAP 924 in processor 208. This involves transmitting to processor 208, via signal(s) 1103-1, one or more DEP(s) applicable to MNO-2 and MS1-9. Also, one or more mobile subscriber records for MS1-9 are transmitted, via signal(s) 1105-1, to processor 208. As applicable, a decryption key is copied into the RAP, as well. Likewise, to generate the filtered record(s) for MS2-53, a second instantiation of RAP 924 is established in processor 208. This involves transmitting to processor 208, via signal(s) 1103-2, one or more DEP(s) applicable to MNO-3 and MS2-53. One or more mobile subscriber records for MS2-53 are transmitted, via signal(s) 1105-2, to processor 208. As applicable, a decryption key is copied into the RAP.

Visited networks MNO-2 and MNO-3 permit respective mobile subscribers MS1-9 and MS2-53 to access the internet in accordance with the permissions and rules contained in the filtered mobile subscriber records generated by Records Exchange System 100. The mobile subscribers thus “use” data. This use of data and other activity by the mobile subscribers is tracked by the visited MNO to the extent permitted and/or required by the rules, etc. contained in the filtered mobile subscriber records.

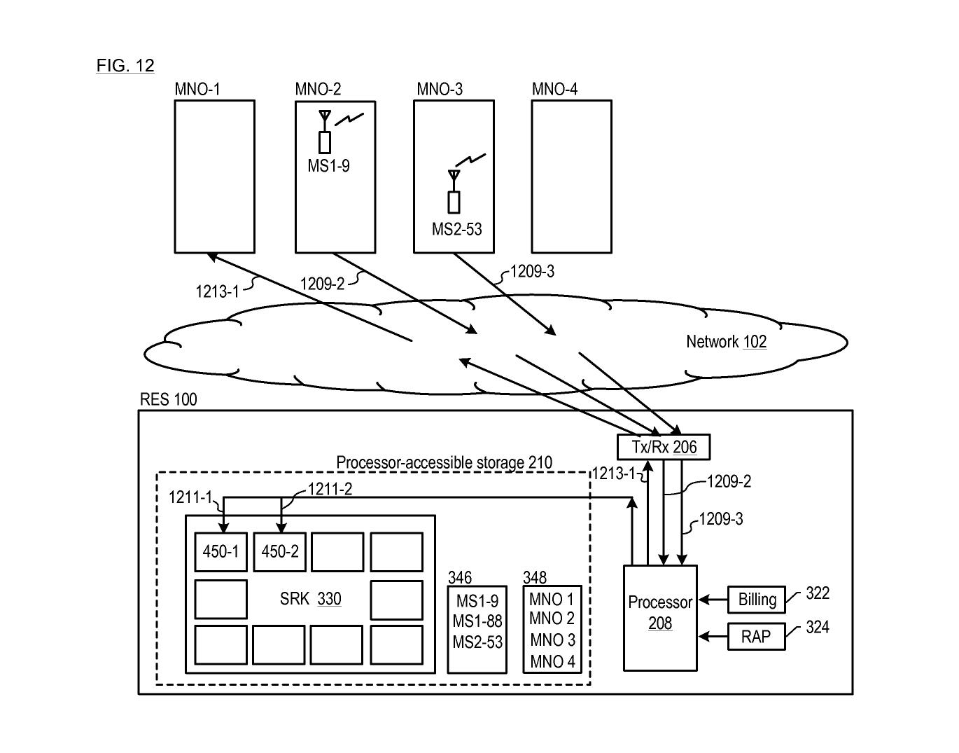

FIG. 12 depicts MNO-2 transmitting to Records Exchange System 100, via signal(s) 1209-2, activity of MS1-9 while roaming in MNO-2. (In some embodiments, a request to transmit the subscriber's activity precedes transmission of the activity.) This figure also depicts MNO-3 transmitting to Records Exchange System 100, via signal(s) 1209-3, activity of MS2-53 while roaming in MNO-3. This data can be transmitted real-time while the subscribers are roaming, or periodically, or after the subscriber leaves a visited network.

RAP 324 or other suitable software organizes the activity data in a form suitable for updating the mobile subscriber records maintained in SRK 330. (See, e.g., FIG. 8.) Signal(s) 1211-1 conveys the updated activity for MS1-9 to storage block 450-1 (for MNO-1) and signal(s) 1211-2 conveys the updated activity for MS2-53 to storage block 450-2 (for MNO-2). Records Exchange System 100 transmits, via signal(s) 1213-1, the updated subscriber activity for subscriber MS1-9 to home network MNO-1.

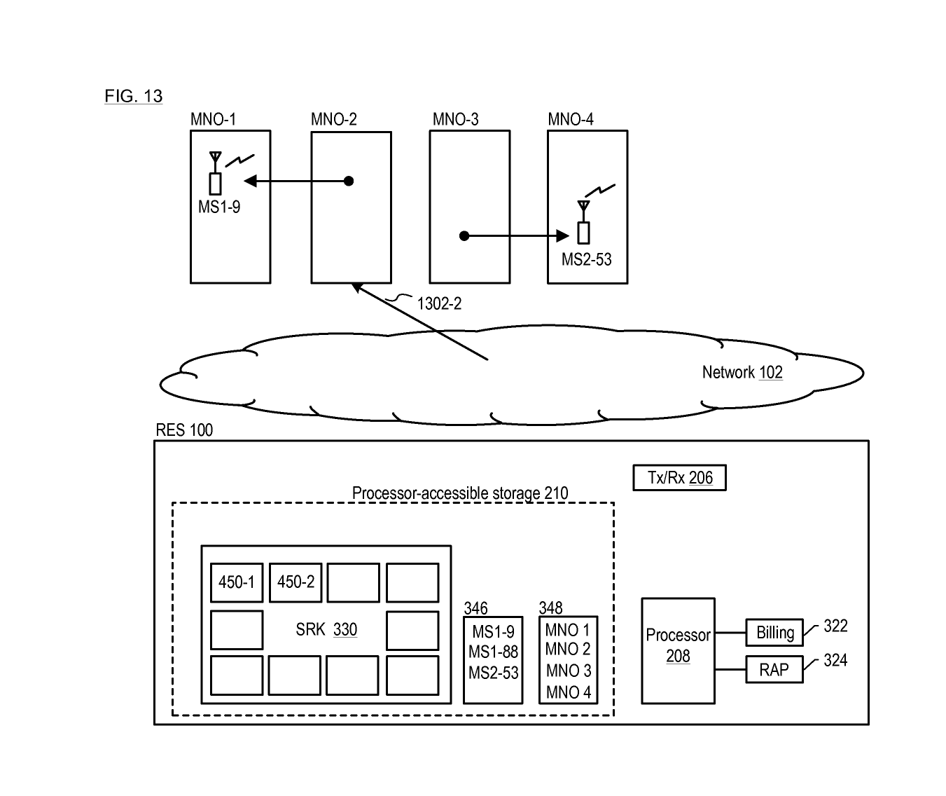

Referring now to FIG. 13, after a period of roaming, MS1-9 returns to home network MNO-1. After a period of roaming, MS2-53 leaves network MNO-3 and moves to a region covered by network MNO-4. Network MNO-4 transmits signal 1302-2 to MNO-2 (optionally through System 100) requesting permission to pick up MS2-53. In this example, MNO-4 receives permission (not depicted) to pick-up MS2-53.

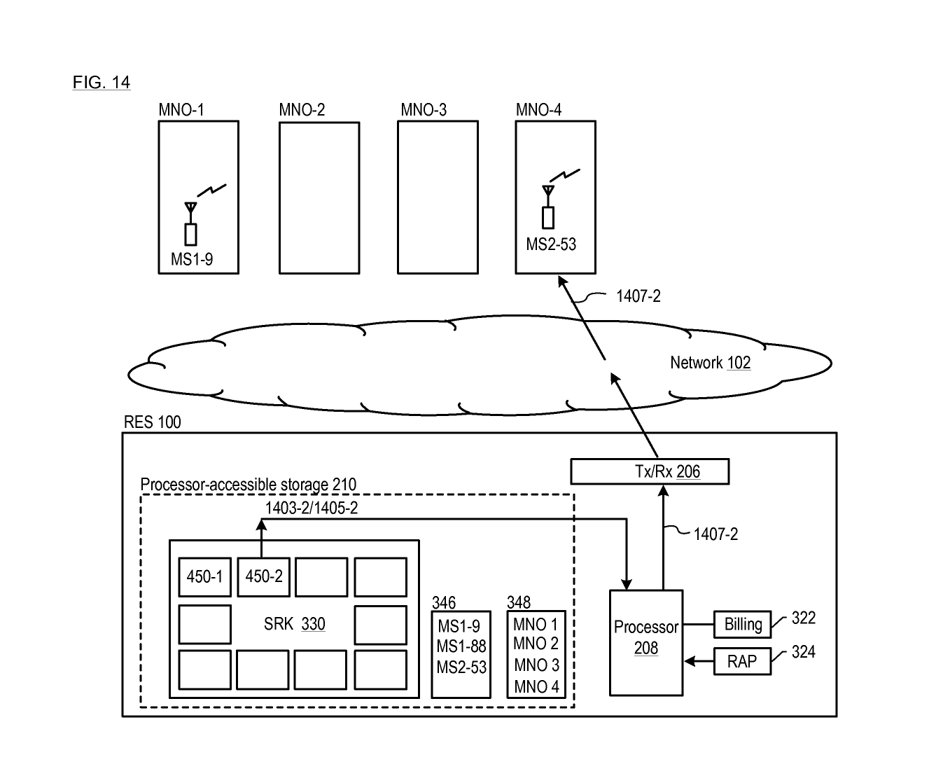

FIG. 14 depicts one or more filtered mobile subscriber records for MS2-53 being transmitted, via signal(s) 1407-2, to network MNO-4. As previously mentioned, the filtered records are transmitted in response to a request (not depicted) to receive the filtered mobile subscriber records (from either the visited network or the home network). Although depicted as being transmitted from System 100 to MNO-4, the filtered records can be delivered to the home network (from System 100) for re-delivery to the visited network.

As previously discussed, filtered record(s) for MS2-53 are generated by establishing an instantiation of RAP 924 in processor 208. This involves transmitting to processor 208, via signal(s) 1403-2, one or more DEP(s) applicable to MNO-4 and MS2-53. Also, one or more mobile subscriber records for MS2-53 are transmitted, via signal(s) 1405-2, to processor 208. Note that the mobile subscriber records will reflect the activity of MS2-53 while roaming in MNO-3. For example, to the extent that MS2-53 accessed data while roaming, the information forwarded to MNO-4 will reflect the fact the subscriber has some lesser amount of data access available, in accordance with the subscriber's plan. It is notable that the actual activity of MS2-53 while roaming in MNO-3 will not be revealed to MNO-4; rather, the net effect of that roaming activity will be reflected in the filtered records. As applicable, a decryption key is copied into the RAP, as well.

Visited network MNO-4 permits mobile subscriber MS2-53 to access the internet or perform other broadband roaming activities in accordance with the permissions and rules contained in the filtered mobile subscriber records generated by Records Exchange System 100. Usage of the network by subscriber MS2-53 is tracked by the visited MNO to the extent permitted and/or required by the rules, etc. contained in the filtered mobile subscriber records.

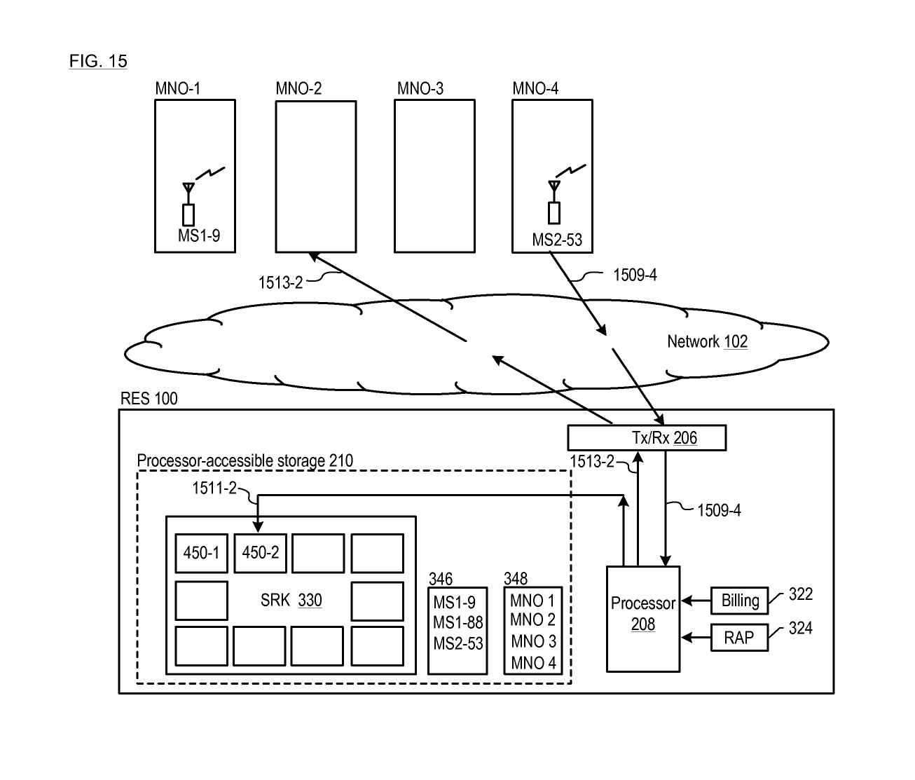

FIG. 15 depicts MNO-4 transmitting to Records Exchange System 100, via signal(s) 1509-4, activity of MS2-53 while roaming in MNO-4. (In some embodiments, a request to transmit the subscriber's activity precedes transmission of the activity.) As previously noted, this data can be transmitted real-time while the subscribers are roaming, or periodically, or after the subscriber leaves a visited network.

RAP 324 or other suitable software organizes the activity data in a form suitable for updating the mobile subscriber records maintained in SRK 330. (See, e.g., FIG. 8.) Signal(s) 1511-2 conveys the updated activity for MS2-53 to storage block 450-2 for MNO-2. Records Exchange System 100 transmits, via signal(s) 1513-2, the updated subscriber activity for subscriber MS2-53 to home network MNO-2.

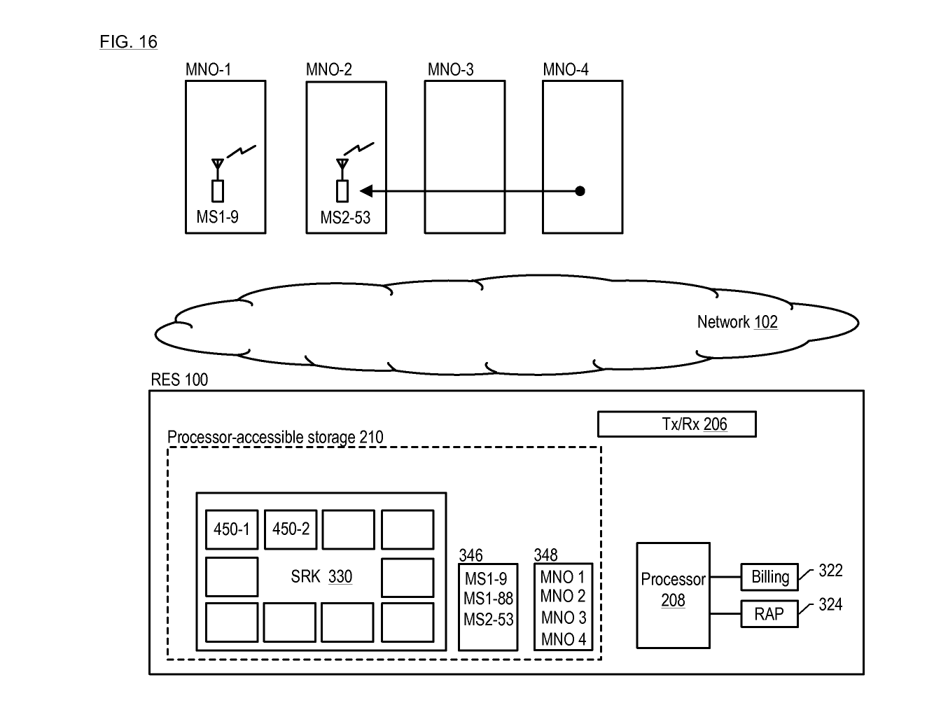

Referring to FIG. 16, after a period of roaming, MS2-53 returns to home network MNO-2.

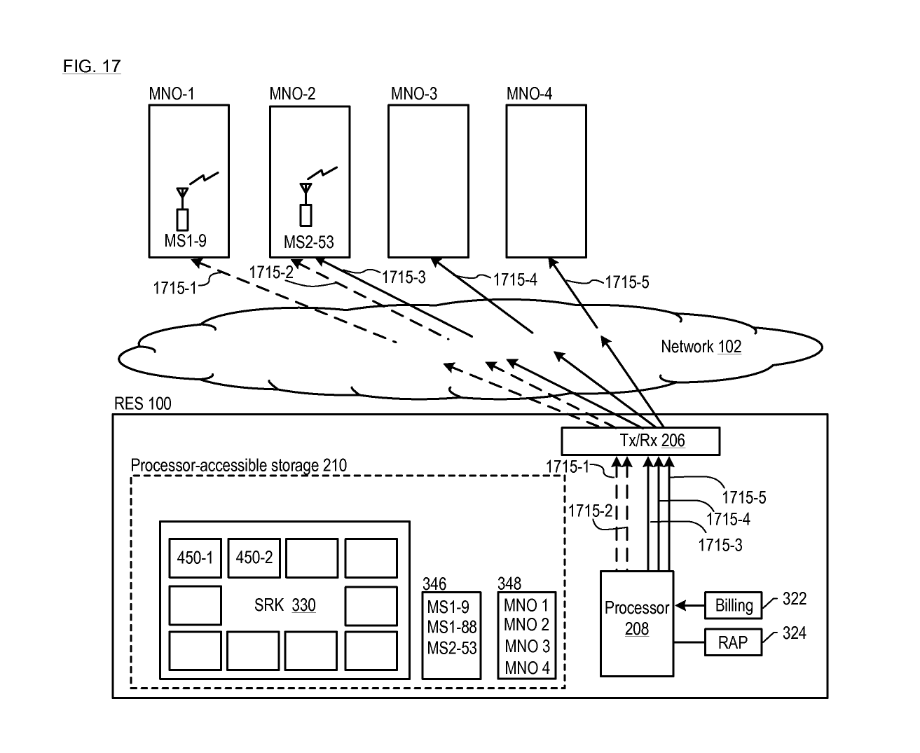

FIG. 17 depicts Records Exchange System 100 settling the charges between the various Participating MNOs. At an appropriate time as a function of a subscriber's billing cycle, Billing System 322 aggregates billing data for mobile subscriber MS1-9. Billing System 322 rates use of services, data usage, etc., by subscriber MS1-9 according to an appropriate tariff scheme and ultimately generates an invoice. Billing System 322 generates revenue sharing data that enables home network MNO-1 and visited network MNO-2 to share revenue based on the subscriber's activity in those networks. Records Exchange System 100 generates and transmits signals 1715-1 and 1715-2 conveying MS1-9 billing information to home network MNO-1 and visited network MNO-2, respectively. The operator of System 100 receives a fee for services of the System, which Billing System 322 applies to the network operators.

Billing System 322 of Records Exchange System 100 aggregates the billing data for mobile subscriber MS2-53 and rates the subscriber's use of services, data usage, etc. according to an appropriate tariff scheme and ultimately generates an invoice. Billing System 322 generates revenue sharing data that enables home network MNO-2 and visited networks MNO-3 and MNO-4 to share revenue based on the subscriber's activity in those networks. Records Exchange System 100 generates and transmits signal 1715-3, 1715-4, and 1715-5 conveying MS2-53 billing information to home network MNO-2 and visited networks MNO-3 and MNO-4. The operator of System 100 receives a fee for services of the System, which Accounting/Billing System 322 applies to the network operators.

It is to be understood that many variations of the invention can easily be devised by those skilled in the art after reading this disclosure and that the scope of the present invention is to be determined by the following claims.

What is claimed is:

1. A method comprising:
receiving, at a data processing system, one or more first signals comprising selected mobile subscriber data for a first mobile subscriber from a first participating mobile network operator (MNO);
filtering, in the data processing system, the selected mobile subscriber data using a first data exchange package that is applicable to the first mobile subscriber and a second participating MNO, thereby generating a first filtered mobile subscriber record;
transmitting, from the data processing system to the second participating MNO, the first filtered mobile subscriber record via one or more second signals;
receiving, at the data processing system, at least one or more third signals from the second participating MNO, wherein the third signal conveys information pertaining to activity of the first mobile subscriber in the second participating MNO's network; and
apportioning, in the data processing system, charges applicable to the first mobile subscriber for services provided thereto by the first participating MNO and the second participating MNO, between the first participating MNO and the second participating MNO.

2. The method of claim 1 and further comprising the task of storing the selected mobile subscriber data in a secure data base accessible to the data processing system.

3. The method of claim 1 and further comprising the task of storing the first data exchange package in a data base accessible to the data processing system.

4. The method of claim 1 and further comprising the task of establishing, in processor-accessible storage, a list of participating MNOs, including the first participating MNO and the second participating MNO, wherein the participating MNOs appearing in the list perform at least one of the following tasks:
(a) send selected mobile subscriber data to the data processing system; and
(b) receive filtered mobile subscriber data from the data processing system.

5. The method of claim 1 and further comprising the task of establishing a list, in processor-accessible storage of the data processing system, for mobile subscribers, including the first mobile subscriber, who give permission to have selected mobile subscriber data filtered and transmitted to participating MNOs.

6. The method of claim 1 and further comprising the task of updating, in the data processing system, the selected mobile subscriber data of the first mobile subscriber based on the information conveyed by the third signal.

7. The method of claim 6 and further wherein the task of updating the selected mobile subscriber data further comprises converting, in the data processing system, the information conveyed by the third signal to a format suitable for storage in a secure database accessible to the data processing system.

8. The method of claim 1 and further comprising the task of transmitting a fourth signal to the first participating MNO, wherein the fourth signals conveys information pertaining to the activity of the first mobile subscriber in the second participating MNO's network.

9. The method of claim 7 and further wherein the task of transmitting the fourth signal further comprises converting, in the data processing system, the information conveyed by the third signal to a format suitable for use by the first participating MNO.

10. The method of claim 1 wherein the data processing system transmits the first filtered mobile subscriber record to the second participating MNO after the data processing system receives notification that second participating MNO will provide roaming service to the first mobile subscriber.

11. The method of claim 1 and further comprising filtering, in the data processing system, the selected mobile subscriber data using a second data exchange package that is applicable to the first mobile subscriber and a third participating MNO, thereby generating a second filtered mobile subscriber record.

12. The method of claim 11 and further comprising transmitting, from the data processing system to the third participating MNO, the second filtered mobile subscriber record via one or more fourth signals.

13. The method of claim 11 and further comprising the task of storing the first data exchange package and the second data exchange package in a data base accessible to the data processing system.

14. The method of claim 12 and further comprising receiving, at the data processing system, at least one or more fifth signals from the third participating MNO, wherein the fifth signal conveys information pertaining to activity of the first mobile subscriber in the third participating MNO's network.

15. A method comprising:
receiving, at a data processing system, one or more first signals comprising first selected mobile subscriber data for a first mobile subscriber from a first participating mobile network operator (MNO);
receiving, at a data processing system, one or more second signals comprising second selected mobile subscriber data for a second mobile subscriber from a second participating mobile network operator (MNO);
filtering, in the data processing system, the first selected mobile subscriber data using a first data exchange package that is applicable to the first mobile subscriber and the second participating MNO, thereby generating a first filtered mobile subscriber record;
filtering, in the data processing system, the second selected mobile subscriber data using a second data exchange package that is applicable to the second mobile subscriber and a third participating MNO, thereby generating a first second mobile subscriber record;
transmitting, from the data processing system to the second participating MNO, the first filtered mobile subscriber record via one or more third signals;
transmitting, from the data processing system to the third participating MNO, the second filtered mobile subscriber record via one or more fourth signals;
receiving, at the data processing system, at least one or more fifth signals from the second participating MNO, wherein the fifth signal conveys information pertaining to activity of the first mobile subscriber in the second participating MNO's network; and
receiving, at the data processing system, at least one or more sixth signals from the third participating MNO, wherein the sixth signal conveys information pertaining to activity of the second mobile subscriber in the third participating MNO's network.

16. The method of claim 15 and further comprising the task of updating, in the data processing system, the first selected mobile subscriber data of the first mobile subscriber based on the information conveyed by the fifth signal.

17. The method of claim 16 and further comprising the task of updating, in the data processing system, the second selected mobile subscriber data of the second mobile subscriber based on the information conveyed by the sixth signal.

18. The method of claim 17 and further comprising the tasks of:
transmitting one or more seventh signals to the first participating MNO, wherein the seventh signal conveys information pertaining to the activity of the first mobile subscriber in the second participating MNO's network; and
transmitting one or more eighth signals to the second participating MNO, wherein the eighth signal conveys information pertaining to the activity of the second mobile subscriber in the third participating MNO's network.

19. The method of claim 15 and further comprising the tasks of:
apportioning, in the data processing system, charges applicable to the first mobile subscriber for services provided thereto by the first participating MNO and the second participating MNO, between the first participating MNO and the second participating MNO; and
apportioning, in the data processing system, charges applicable to the second mobile subscriber for services provided thereto by the second participating MNO and the third participating MNO, between the second participating MNO and the third participating MNO.

20. A method comprising:
filtering, in a data processing system, selected mobile subscriber data for a mobile subscriber of a first participating mobile network operator (MNO) using a first data exchange package that is applicable to the mobile subscriber and a second participating MNO, thereby generating a first filtered mobile subscriber record;
transmitting, from the data processing system to the second participating MNO, the first filtered mobile subscriber record via one or more first signals;
receiving, at the data processing system, at least one or more second signals from the second participating MNO, wherein the second signal conveys information pertaining to activity of the first mobile subscriber in the second participating MNO's network; and
settling, in the data processing system, charges applicable to the first mobile subscriber for services provided thereto by the first participating MNO and the second participating MNO.
